(19) United States
(12) Patent Application Publication
(10) Pub. No.: US 2007/0204344 A1
(43) Pub. Date: Aug. 30, 2007

(54) Parallel Variable Length Pattern Matching Using Hash Table

(76) Inventor: Chun Xue, Richardson, TX (US)

Correspondence Address: Chun Xue, 2904 Wren Ln, Richardson, TX, 75082, US

(21) Appl. No.: 11/307,864

(22) Filed: Feb. 26, 2006

(51) Int. Cl. G06F 12/14

(52) U.S. Cl. 726/24

(57) ABSTRACT

Fast pattern matching is the heart of Network Intrusion Detection. A method that applies hash function to pattern matching for variable length patterns is proposed. Pattern matching always can be completed in O (log M) steps where M is the longest pattern length.

### BACKGROUND OF THE INVENTION

Network Intrusion Detection System (NIDS) performs packet inspection to identify, prevent and inhibit malicious attacks over internet. It can effectively stop viruses, worms, and spams from wide spreading. Pattern matching is the key component in the network intrusion detection systems. Traditionally, network intrusion detection systems are implemented in software. Snort is a well-known open source software network intrusion detection system. It matches pattern database against each packet to identify malicious target connections. With the rapid growth of pattern database, and the rapid growth of network bandwidth, software only solution can not process the internet traffic in full network link speed. A natural approach will be to move the computation intensive pattern matching to hardware. The main idea is to use specialized hardware resources along with a conventional processor. In this way, the conventional CPU can process all the general-computing tasks and the specialized co-processor can deal with string pattern matching, where parallelism, regularity of computations can be exploited by custom hardware resources.

### SUMMARY OF THE INVENTION

This invention is a novel hardware solution for pattern matching in NIDS. While using hash tables, variable pattern length are handled naturally from the beginning. Basically, each pattern is sliced into substrings of length 2ⁱ, where 0<=i<=k, k=log (M), and M is the maximum pattern length. A hash table will be constructed for each substring length. There will be a total of k number of hash tables. Input string is processed in an iterative fashion. First, all substrings of length 2^{k} of the input string is matched against the hash table for substring length 2^{k}. Then, all substrings of length 2^{k-1} of the input string is matched against the hash table for substring length 2^{k-1}. Until all substrings of length one is matched against hash table for substring length one. A match is declared when all substrings of a pattern are matched.

### BRIEF DESCRIPTION OF THE DRAWINGS

FIG. 0 Architecture Block Diagram.

FIG. 1 A Processing Element (PE).

FIG. 2 Pattern_Length table.

FIG. 3 HASH_{—}0 table.

FIG. 4 HASH_i table and Sup_Table.

FIG. 5 Match_Table.

### DETAILED DESCRIPTION OF THE INVENTION

Architecture

The block diagram of our proposed architecture is shown in FIG. 0. In this architecture, the core elements are an array of PEs (Processing Element). The number of PEs equals to the size of the input string S. A PE processes a substring of the input against all the same length substrings of the patterns. The input string is processed in rounds of different substring length. Each PE will first process all the 2^{k} bytes substring of the input string, then 2^{k-1}, etc.

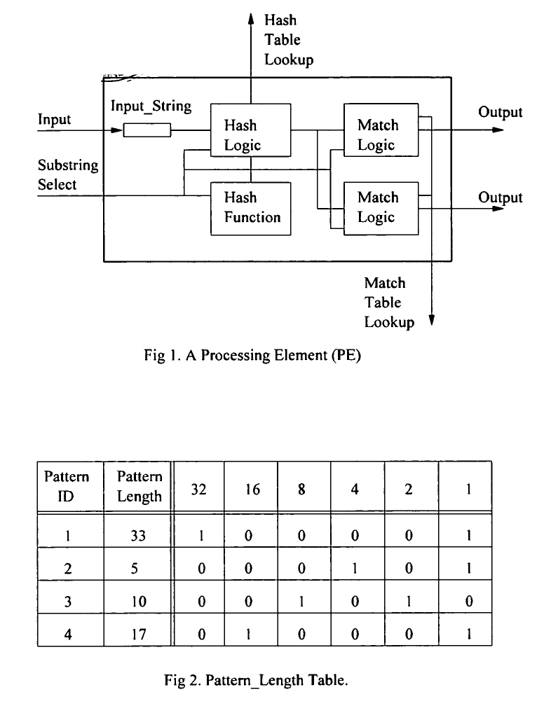

The design diagram of a PE is shown in FIG. 1. The inputs of a PE are a substring and a substring select signal that determines the length of the substring that will be worked on. First the input string will be passed to the hash function block and a hashing value will be obtained. This hash value will be used to do a hash table lookup. The result of hash table lookup will be passed to the match logic block to determine if there is a match or not. The design of each PE is kept simple. Duplicated hardware is used for the Match Logic block to increase the performance.

Basic Concepts and Data Structures

Let us first define the problem that we are trying to solve. Assuming a packet carries a string S of length L, and we know a set of N patterns, p[1], p[2], . . . , p[N], the goal of Network Intrusion Detection System (NIDS) is to determine if there is any exact matching between pattern p[i] and a substring of S. Let M be the maximum pattern length, and let k=log M. The main idea of our approach is to slice each pattern into substrings of length 2ⁱ, where 0<=i<=k. Input data string S is read in as a whole and processed in rounds of different substring length. First all substrings of length 2^{k} are processed, then all substrings of length 2^{k-1}, etc. The whole matching is completed in k steps.

After finding a match of a substring, we will first decide if all the previous substrings in the pattern are matched. If yes, then a partial match is identified. And then, we will see if this is the last substring in the partially matched pattern. If yes, then a potential exact match is declared and a red flag will be raised by the network intrusion detection system and processed accordingly by the host system.

Three sets of data structures are used in our approach, and we will introduce them one by one. The first data structure of interest is the Pattern_Length table. It is an array that stores each pattern's length and indexed by the pattern ID. The binary representation of each pattern length shows what substrings that this pattern will be decomposed into. An example is shown in FIG. 2. In this example, for the first pattern with pattern ID equals to 1 and length equals to 33, it will be sliced into a substring of length 32 and a substring of length 1, as depicted by its binary representation in FIG. 2.

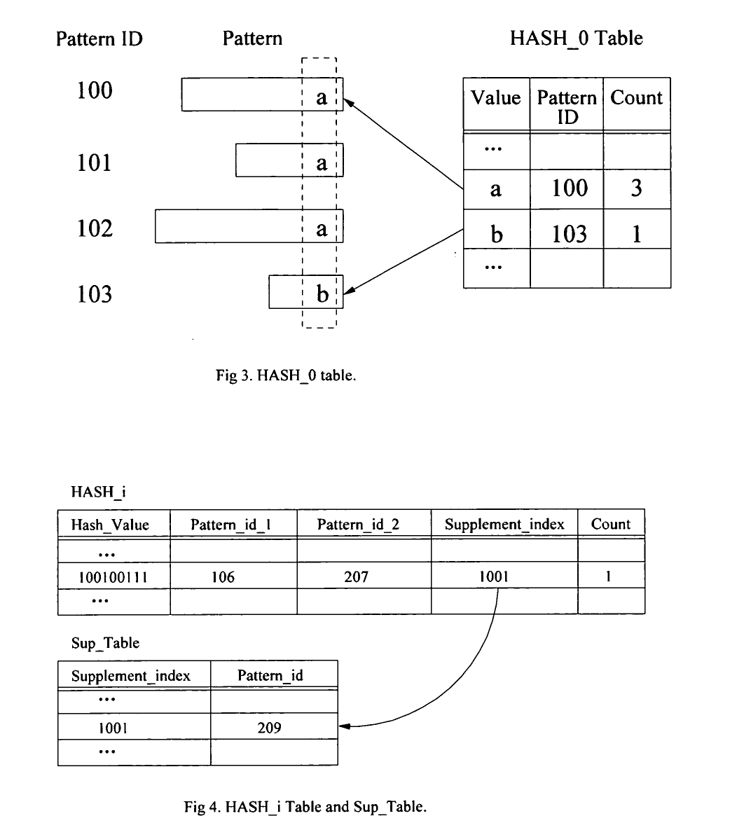

The second set of data structure of interest is a set of hash tables that stores the pre-processed information for each substrings of each patterns. For pattern substrings of length 1, since there can only be 256 values, no hashing is done. Instead, a table of 256 entries is created. Each entry contains three elements, the first element is the value of this entry, the second element is the starting pattern ID, and the third element is the number of patterns that have the same value from the starting pattern ID. An example is shown in FIG. 3. In this example, there are three patterns with value “a” as the last byte. Hence, in the HASH_{—}0 table, there is an entry with value equal to “a”, starting pattern ID equal to 100, and number of consecutive patterns equal to 3.

For substring length greater than 1, a hash table is constructed for each substring length. Hash table HASH_i correspond to substring length 2ⁱ, where i!=0. Index of each hash table is the hashing value, and the entries in the hash tables are the pattern IDs. An example of hash table when substring length is not equal to zero is shown in FIG. 4. There are five columns in each hash table. Extra columns are used to handle hashing collisions. There are two sources of potential hashing collisions exist in our scheme. First, different substrings could be hashed to the same hash value. Second, different patterns could have the same substring. For example, pattern “hell” and pattern “hello” have the same 4 bytes substring “hell”. To handle hashing collisions efficiently, for each hash value, we reserve two space for pattern ID in column two and column three respectively. These two pattern ID will be read in the same clock cycle and processed by hardware simultaneously. When there are more than 2 substrings are hashed to the same value, a separate table called Sup_Table is used to record these values. Sup_Table is also shown in FIG. 4. Column four of the HASH_i table points to the starting Supplement_index, and column five identify the number of consecutive entries in the Sup_Table that have the same hash value. In the example shown in FIG. 4, for hash value “100100111”, there are three patterns total have this hash value, pattern 106, pattern 207 and pattern 209 as recorded in Sup_Table in entry 1001.

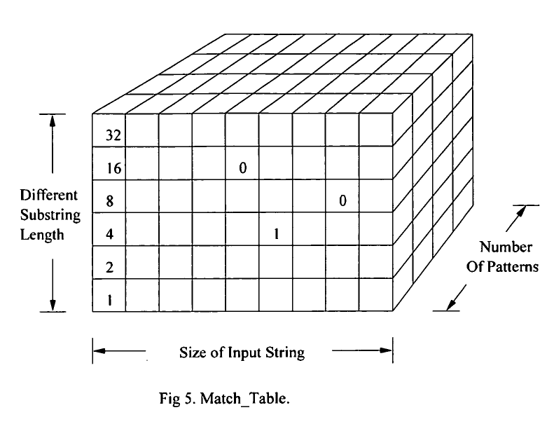

The third data structure that we use is the Match_Table, which is a three-dimensional bit array, with length equals to the input string length L, width equals to the number of patterns N, and the height equals to number of different substring length k. This table is used to record the substring matches found, which is in turn used for determining whole pattern match. For each substring match, a “1” will be recorded using the substring length, matched pattern id, and the position of the substring in the input string S. An example is showing in FIG. 5. In this example, there are six different substring length, 1, 2, 4, 8, 16, and 32. Hence Match_Table has a height of 6.

Algorithms

In this section, the algorithms of our approach are presented. An example is given at the end of this section to show how the algorithms work. There are two main algorithms in our approach. Algorithm Init_Matching handles the initialization of all the necessary data structures. The second algorithm Pattern_Matching processes the input strings for potential matching.
Algorithm: Init_Matching
Input: A set of patterns p.
Output: Initialized data structures.

Sort all the odd length patterns by the value of the last byte;

\FORALL{ pattern p[i] }

Pattern_Length[i] = length(p[i]);

\ENDFOR
\FORALL{ pattern p[i]}

\FOR{ each substring s in p[i] }

hashed_value = HASH(s);
set HASH_j[hashed_value] = i;

\ENDFOR

\ENDFOR
\FOR{j = 0 to 255}

Insert Starting Pattern ID and number of patterns into HASH_0;

\ENDFOR

In algorithm Init_Matching, first all the odd length patterns are sorted by the value of the last byte. This is necessary for building the lookup table for substring length l. Then for each pattern, Pattern_Length table is populated with the length of the pattern. Afterward, we will hash each substring of each pattern, and store the pattern ID accordingly. Based on our HASH_i table, there are two spaces to store pattern ID. We will first try to store the pattern ID of a particular hash value in one of these two spaces. If both of these two spaces are occupied, we will then place the pattern ID in the Sup_Table and update the last two columns of the HASH_i table accordingly. The last step of the Init_Matching algorithm populates the HASH_{—}0 table with the sorted pattern information. Updating the pattern set when we need to add or remove a pattern can be done in the similar fashion of Algorithm Init_Matching.
Algorithm: Pattern_Matching
Input: String S of length L.

Output: Yes/No. (If there is a substring in the input string S that matches one pattern).

\FORALL{ substring length i}

\FORALL{ substring starting at position j of S}

hashed_value = HASH(substring);
\FOR{ each match in HASH_i }

k = matched pattern ID;
/* Find the pattern length for pattern k */
pl = Lookup the Pattern_Length table for pattern k;
/* Find the previous substring for pattern k */
pre_s = Pre_Substring(pl,i);
\IF{ (pre_s = 0) or ( pre_s > 0 and
Match_Table[j−pre_s][pre_s][k] = 1 ) }

Match_Table[j][i][k] = 1 ;
\IF{ Post_Substring(pl,i) = 0 }

Return Match_found= 1 ;

\ENDIF

\ENDIF

\ENDFOR

\ENDFOR

\ENDFOR

The main algorithm that processes each input string for potential matching patterns is Algorithm Pattern_Matching.

There are two functions notable used in Algorithm Pattern_Matching, i.e., Pre_Substring(pl,i) and Post_Substring(pl,i), where pl is the pattern length and i is the current substring length. These two functions are used to determine if there is other substrings in the current pattern or not. If there are substrings before the current substring with length i in a pattern of length pl, Pre_Substring(pl,i) will return the previous substring length. Otherwise, Pre_Substring(pl,i) will return “0”. Post_Substring(pl,i) will return “1” if there is any substring after the current substring with length i, and return “0” if the current substring is the last substring of the pattern. In Pattern_Matching algorithm, for each substring length and each substring, we will first run the hash function to obtain a hash value. The hash value is used to lookup the corresponding hash table. If there are matches found in the hash table, for each matched pattern ID, we will examine its previous substrings and post substrings. If there is no previous substring or if there is a previous substring and it is also matched to the same pattern, we will mark “1” in the Match_Table for this input substring, at this substring length and this matched pattern. After we mark “¹” in the Match_Table, if this Substring also happens to be the last substring of the pattern, then we declare there is a: potential match.

What is claimed is:

1. A method of performing pattern matching on variable length patterns that completes in O (log M) steps where M is the maximum pattern length, the method comprising:
Slicing all patterns into substrings length of 2^{k}, where 0<=k<=log M;
Building hash table for each substring length;
String to be matched is sliced into substrings and matched against each substring length;
A full match is declared when all substrings of one patent are matched.

2. The pattern according to claim 1, is a set of known signatures of virus, worms and malicious activities from a Network Intrusion Detection System, and the input string is a network stream.
